(19) United States
(12) Patent Application Publication
(10) Pub. No.: US 2024/0405919 A1
(43) Pub. Date: Dec. 5, 2024

(54) ERROR CORRECTION DEVICE AND ERROR CORRECTION METHOD

(71) Applicant: Fujitsu Limited, Kawasaki-shi (JP)

(72) Inventor: Junichi SUGIYAMA, Kawasaki (JP)

(73) Assignee: Fujitsu Limited, Kawasaki-shi (JP)

(21) Appl. No.: 18/651,925

(22) Filed: May 1, 2024

(30) Foreign Application Priority Data
May 29, 2023 (JP) 2023-088063

(51) Int. Cl. H04L 1/00; H04L 41/16

(52) U.S. Cl. CPC H04L 1/0082; H04L 1/0047; H04L 41/16

(57) ABSTRACT

An error correction device includes an error correction circuit configured to repeatedly perform calculation of error correction on a target frame, based on soft decision information, an upper limit value of a number of times of calculation of the repeatedly performed calculation being set, a first calculation circuit configured to count a number of times of repetition of the calculation of the error correction for each frame, and obtain a sum of numbers of times of repetition of a plurality of past frames, and a second calculation circuit configured to set the upper limit value so as to be a value that corresponds to the sum of the numbers of times of repetition and to be a smaller value as the sum of the numbers of times of repetition is greater.

### CROSS-REFERENCE TO RELATED APPLICATION

This application is based upon and claims the benefit of priority of the prior Japanese Patent Application No. 2023-88063, filed on May 29, 2023, the entire contents of which are incorporated herein by reference.

### FIELD

The embodiments discussed herein are related to an error correction device and an error correction method.

### BACKGROUND

Multicarrier transmission enables large-capacity transmission by multiplexing subcarrier signals with low transmission rates of, for example, 20 Gbps, 50 Gbps, and the like. For example, error correction such as soft decision-forward error correction (SD-FEC) is performed on subcarrier signals so as to enable long-distance transmission.

Therefore, subcarrier signals are subjected to encoding processing by, for example, a low density parity-check code (LDPC) in a transmission device. In addition, a turbo code having high error correction capability and adopted in various transmission fields, and the like are also known.

Japanese Laid-open Patent Publication No. 2022-007503 and Japanese Laid-open Patent Publication No. 2009-201057 are disclosed as related art.

### SUMMARY

According to an aspect of the embodiments, an error correction device includes an error correction circuit configured to repeatedly perform calculation of error correction on a target frame, based on soft decision information, an upper limit value of a number of times of calculation of the repeatedly performed calculation being set, a first calculation circuit configured to count a number of times of repetition of the calculation of the error correction for each frame, and obtain a sum of numbers of times of repetition of a plurality of past frames, and a second calculation circuit configured to set the upper limit value so as to be a value that corresponds to the sum of the numbers of times of repetition and to be a smaller value as the sum of the numbers of times of repetition is greater.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of an error correction device according to a first embodiment;

FIG. 2 is a diagram for describing an example of a total number of times;

FIG. 3 is an example of simulation for calculating a set number of times;

FIG. 4 is an example of a graph for determining the set number of times;

FIG. 5 is a flowchart illustrating an example of operation of the error correction device according to the first embodiment;

FIG. 6 is a diagram for describing the number of times of repetition at the time of low quality according to a comparative example;

FIG. 7 is a diagram for describing the number of times of repetition at the time of low quality according to the embodiment;

FIG. 8 is a diagram for describing an example of a correction process of error correction for a high-quality frame;

FIG. 9 is a diagram for describing an example of a correction process of error correction for a medium-quality frame;

FIG. 10 is a diagram for describing an example of a correction process of error correction for a low-quality frame;

FIG. 11 is an example of an error correction device according to a second embodiment;

FIG. 12 is an example of a correspondence table in which quality of a frame and an upper limit value are associated with each other;

FIG. 13 is a flowchart illustrating an example of operation of the error correction device according to the second embodiment;

FIG. 14 is an example of an error correction device according to a third embodiment; and

FIG. 15 is a flowchart illustrating an example of operation of the error correction device according to the third embodiment.

### DESCRIPTION OF EMBODIMENTS

In the LDPC, in a case where a bit error rate is low, the number of times of repetition (for example, the number of times of iteration) of error correction is small in many cases. Therefore, in a case where quality of an error correction target frame is high quality, error correction is performed with low power consumption. However, in a case where the bit error rate is high, the number of times of repetition of error correction increases. Therefore, there is a problem that it is difficult to suppress power consumption needed for error correction in a case where the quality of the target frame is low quality.

Hereinafter, embodiments of techniques to reduce power consumption of the error correction device will be described with reference to the drawings.

### First Embodiment

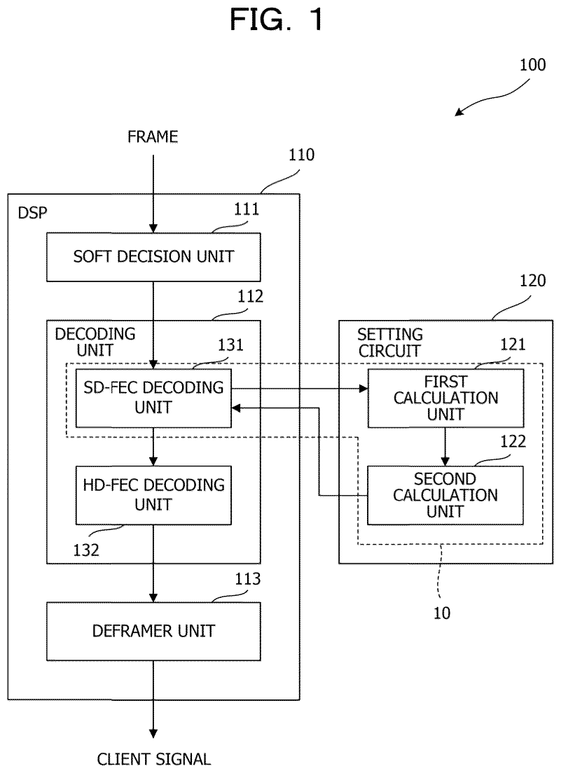

As illustrated in FIG. 1, an error correction device 10 is included in a decoding circuit 100. The decoding circuit 100 is implemented in, for example, a transponder of an optical receiver. The decoding circuit 100 includes a digital signal processor (DSP) 110 and a setting circuit 120. The DSP 110 includes a soft decision unit 111, a decoding unit 112, and a deframer unit 113. The deframer unit 113 may be provided in a framer chip different from the DSP 110. Instead of the DSP 110, a hardware circuit such as a large-scale integration (LSI), a field programmable gate array (FPGA), or an application specific integrated circuit (ASIC) may be adopted.

The soft decision unit 111 performs soft decision on a target frame (hereinafter, simply referred to as a frame) input to the DSP 110 as an error correction target. Examples of the frame input to the DSP 110 include a forward error correction (FEC) frame in which an optical channel transport unit (OTN) frame is provided with FEC, and the like. Hard decision-forward error correction (HD-FEC) parity and soft decision-forward error correction (SD-FEC) parity are included in the frame. Symbols in a constellation are allocated to the frame. The soft decision unit 111 determines likelihood of values “0” and “1” of bit strings from the symbols allocated to the frame. The soft decision unit 111 outputs the frame including the value of each bit string to the decoding unit 112.

The decoding unit 112 corrects the value of the bit string included in the frame. The decoding unit 112 includes an SD-FEC decoding unit 131 and an HD-FEC decoding unit 132. The SD-FEC decoding unit 131 is an example of an error correction circuit.

The SD-FEC decoding unit 131 corrects the value of the bit string included in the frame by repeatedly performing calculation of error correction on the frame based on the SD-FEC (for example, low density parity-check code (LDPC)) parity as soft decision information. For example, the SD-FEC decoding unit 131 performs decoding by using the SD-FEC parity. An upper limit value of the number of times of calculation of the repeatedly performed calculation is set in the SD-FEC decoding unit 131. The SD-FEC decoding unit 131 outputs the frame including each bit string to the HD-FEC decoding unit 132.

The HD-FEC decoding unit 132 corrects the value of each bit string included in the frame based on the HD-FEC parity. For example, the HD-FEC decoding unit 132 performs decoding by using the HD-FEC parity. The HD-FEC decoding unit 132 outputs another frame including each bit string to the deframer unit 113. As the another frame output by the HD-FEC decoding unit 132, for example, an OTN frame obtained by removing FEC from an FEC frame corresponds.

The deframer unit 113 extracts a client signal from the another frame by performing demapping, and outputs the client signal to, for example, a transmission/reception module (not illustrated). The setting circuit 120 performs various types of setting on the DSP 110. The setting circuit 120 includes a first calculation unit 121 and a second calculation unit 122. The first calculation unit 121 is an example of a first calculation circuit. The second calculation unit 122 is an example of a second calculation circuit. The error correction device 10 may be implemented by the first calculation unit 121, the second calculation unit 122, and the SD-FEC decoding unit 131.

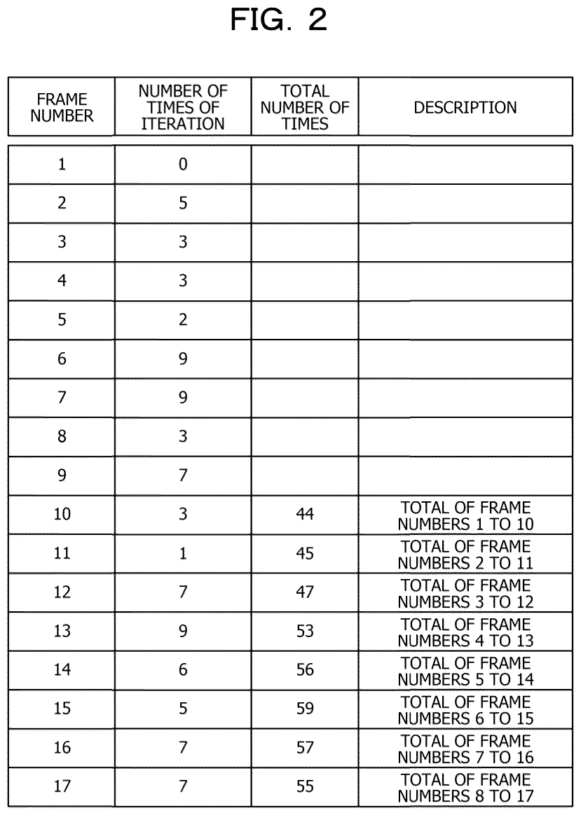

The first calculation unit 121 calculates a total number of times of the number of times of repetition of error correction and the number of times of past repetition. For example, the first calculation unit 121 counts the number of times of repetition of calculation of error correction for each frame. Then, the first calculation unit 121 calculates a sum (for example, sum total) of the numbers of times of repetition of past two or more plurality of frames, and calculates a total number of times of the counted number of times of repetition and the sum total. For example, as illustrated in FIG. 2, in a case where a frame with a frame number “10” is a target of error correction, the first calculation unit 121 acquires the number of times of repetition (the number of times of iteration) of error correction performed on the frame with the frame number “10” from the SD-FEC decoding unit 131. In the present embodiment, the first calculation unit 121 acquires the number of times of repetition “3”. On the other hand, the first calculation unit 121 holds a sum total of the numbers of times of repetition of error correction performed on past frames with a frame number “1” to a frame number “9”. In the present embodiment, the first calculation unit 121 holds a sum total “41” of the numbers of times of repetition. The first calculation unit 121 sums up the number of times of repetition “3” and the sum total “41” of the numbers of times of repetition to calculate a total number of times “44”.

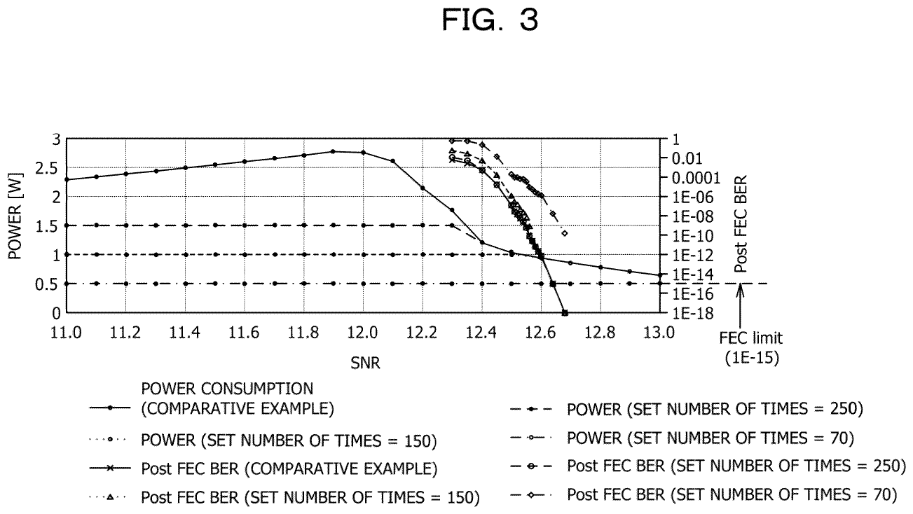

The second calculation unit 122 sets the upper limit value described above so as to be a value corresponding to the sum of the numbers of times of repetition and to be smaller value as the sum of the numbers of times of repetition is greater. For example, based on the total number of times calculated by the first calculation unit 121 and a set number of times determined in advance, the second calculation unit 122 calculates and sets an upper limit value of the number of times of repetition of error correction for a frame input next to an error correction target frame. For example, the second calculation unit 122 sets a value obtained by subtracting the sum of the numbers of times of repetition from the predetermined set number of times as the upper limit value. The set number of times is determined in advance by executing simulation of a relationship between correction performance of error correction and power consumption of the transponder. For example, as illustrated in FIG. 3, three types of the set number of times “250”, “150”, and “70” are prepared, and the simulation is executed.

In a case where the set number of times “250” is adopted and the simulation is executed, a post FEC bit error rate (BER) representing correction performance of the decoding unit 112 becomes smaller than 1E-15 (1.0×10⁻¹⁵) which is an FEC limit, and a desirable result is obtained as a whole similarly to a comparative example. The FEC limit is an example of a request value of received signal quality for suppressing the number of times of error correction to a predetermined number of times. However, in a case where the set number of times “250” is adopted and the simulation is executed, the power consumption is reduced as compared with that of the comparative example.

Also in a case where the set number of times “150” is adopted and the simulation is executed, the Post FEC BER is smaller than 1E-15 which is the FEC limit, and a desirable result is obtained as a whole similarly to the comparative example. On the other hand, in a case where the set number of times “150” is adopted and the simulation is executed, the power consumption is further reduced as compared with the case where the set number of times “250” is adopted and the simulation is executed. In this way, when the set number of times “150” is adopted, a desirable result is obtained as compared with the case where the set number of times “250” is adopted and the simulation is executed.

Note that, in a case where the set number of times “70” is adopted and the simulation is executed, the power consumption is further reduced as compared with the case where the set number of times “150” is adopted and the simulation is executed. However, the Post FEC BER is not smaller than 1E-15 which is the FEC limit, and a desirable result is not obtained as a whole as compared with the comparative example. In this way, in a case where the three types of the set number of times “250”, “150”, and “70” are prepared and the simulation is executed, a better simulation result is obtained with the set number of times “150” than with the set numbers of times “250” and “70”.

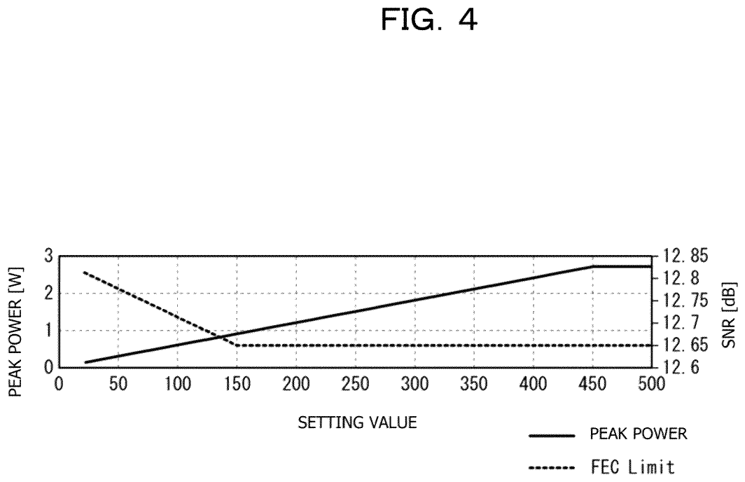

As illustrated in FIG. 4, a graph for determining the set number of times is generated in advance based on a result of the preparation of such three types of the set number of times “250”, “150”, and “70” and the execution of the simulation. According to the graph, since a signal to noise ratio (SNR) representing signal quality of a received signal is constant, deterioration of FEC performance is suppressed. Therefore, when the minimum value “150” at which it may be determined that the deterioration of the FEC performance does not occur is adopted as a setting value, peak power may be suppressed as compared with a case where a value greater than the minimum value “150” is adopted as the setting value.

In this way, based on the set number of times determined in advance and the total number of times, the second calculation unit 122 calculates the upper limit value of the number of times of repetition of the error correction for the frame input next to the error correction target frame. For example, the second calculation unit 122 calculates the upper limit value of the number of times of repetition by calculating a difference by the following mathematical expression.

Upper limit value of the number of times of repetition=set number of times-total number of times Mathematical Expression:

The second calculation unit 122 sets the upper limit value of the number of times of repetition calculated in this way in the SD-FEC decoding unit 131. As a result, the number of times of repetition of the error correction for the next frame input to the SD-FEC decoding unit 131 is limited to the upper limit value. Note that, in the present embodiment, the second calculation unit 122 adopts the mathematical expression as an example, but may adopt a correspondence table in which the upper limit value of the number of times of repetition and the total number of times are associated with each other. Furthermore, the second calculation unit 122 may determine the set number of times based on the FEC limit without determining the set number of times in advance. In this case, the second calculation unit 122 may determine the set number of times to a value that suppresses an increase in the power consumption in received signal quality smaller (or lower) than the FEC limit.

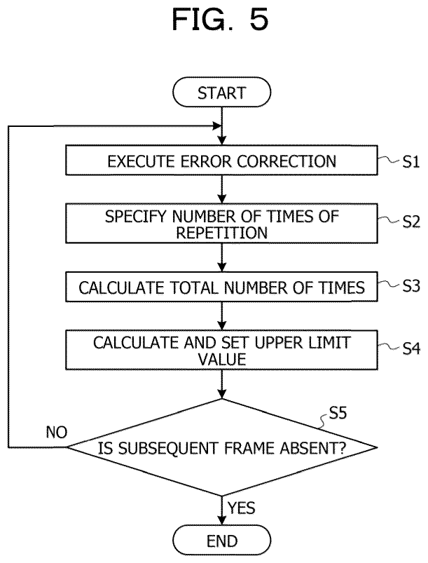

Operation of the error correction device 10 will be described with reference to FIG. 5.

When a frame is input from the soft decision unit 111, the SD-FEC decoding unit 131 executes error correction for the frame (operation S1). When the processing of operation S1 ends, the SD-FEC decoding unit 131 specifies the number of times of repetition needed for the error correction of the frame (operation S2). When the processing of operation S2 is completed, the first calculation unit 121 calculates a total number of times (operation S3). For example, the first calculation unit 121 acquires the number of times of repetition specified by the SD-FEC decoding unit 131, and calculates the total number of times obtained by totaling a sum total of the numbers of times of past repetition held by the first calculation unit 121 and the acquired number of times of repetition.

When the processing of operation S3 is completed, the second calculation unit 122 calculates an upper limit value, and sets the upper limit value in the SD-FEC decoding unit 131 (operation S4). For example, the second calculation unit 122 calculates the upper limit value by subtracting the total number of times from a set number of times, and sets the calculated upper limit value in the SD-FEC decoding unit 131. When the processing of operation S4 is completed, the SD-FEC decoding unit 131 determines presence or absence of a subsequent frame (operation S5).

In a case where there is a subsequent frame (operation S5: NO), the error correction device 10 repeats the processing from operation S1 to operation S4. As a result, the upper limit value is calculated every time the frame is input, and set in the SD-FEC decoding unit 131. On the other hand, in a case where there is no subsequent frame (operation S5: YES), the SD-FEC decoding unit 131 ends the processing.

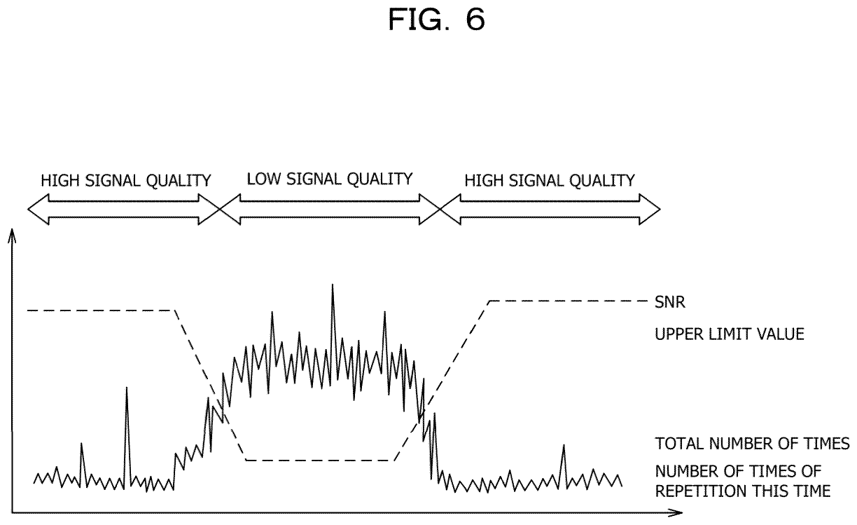

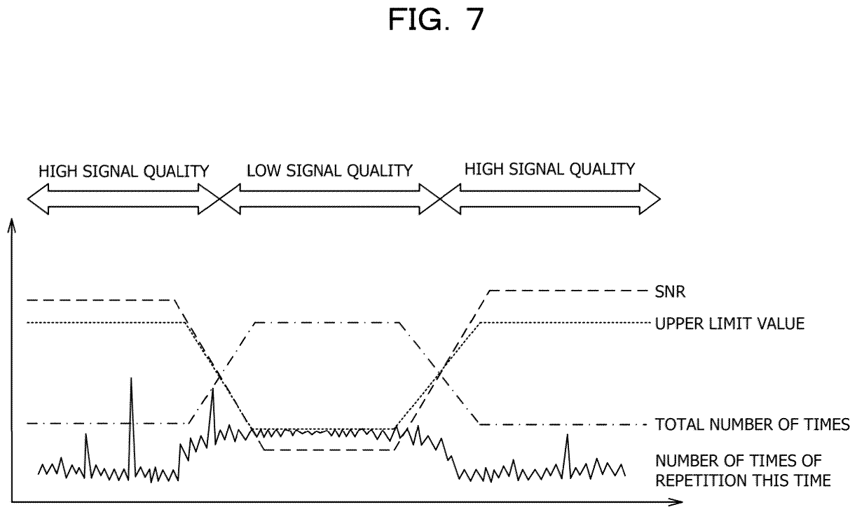

An effect of the present embodiment will be described in comparison with the comparative example with reference to FIGS. 6 and 7.

First, as illustrated in FIG. 6, in the case of the comparative example having no upper limit value, when quality of an error correction target frame is high quality, the number of times of repetition needed for error correction decreases. As the number of times of repetition decreases, the power consumption may be suppressed low. However, in the case where there is no upper limit value, when the quality of the error correction target frame is low quality, the number of times of repetition needed for error correction may increases as compared with the case of high quality. As the number of times of repetition increases, the power consumption increases.

However, as illustrated in FIG. 7, in the case of the embodiment having the upper limit value, when the quality of the error correction target frame is high quality, the number of times of repetition needed for error correction decreases similarly to the case of the comparative example. As a result, the power consumption may be suppressed low. However, in the case where there is the upper limit value, when the quality of the error correction target frame is low quality, the upper limit value is determined by a constant set number of times and a variable total number of times, and thus the number of times of repetition needed for error correction is limited to the upper limit value. As a result, in a case where the quality of the error correction target frame is low quality, the number of times of repetition decreases, and the power consumption is reduced. In this way, according to the present embodiment, in a case where quality of a frame is low quality, the number of times of repetition needed for error correction is dynamically limited to an upper limit value, and reduction of the power consumption may be implemented.

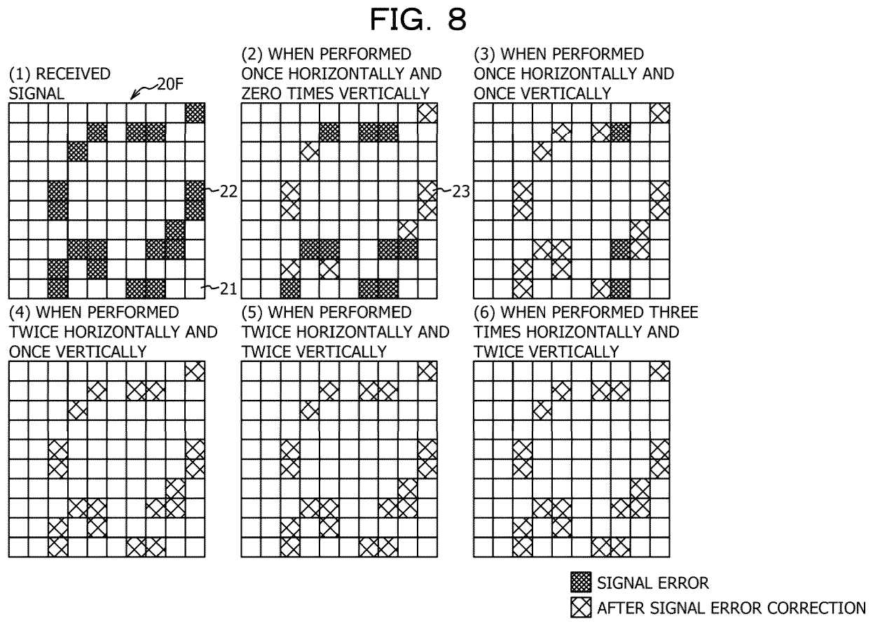

A correction process at the time of error correction for values “0” and “1” of bit strings will be described with reference to FIGS. 8 to 10. In individual regions 21, 22, and 23 included in bit strings of each frame 20F illustrated in FIGS. 8 to 10, either the value “0” or the value “1” is included. In the individual regions 21, correct values that do not need error correction are stored. In the individual regions 22, incorrect values that need error correction are stored. In the individual regions 23, error-corrected values after error correction are stored.

First, as illustrated on a left side in an upper part of FIG. 8, in a case where the frame 20F having a low error frequency is input as a received signal to the SD-FEC decoding unit 131, when the first error correction is performed once in a horizontal direction, some of the individual regions 22 are replaced with the individual regions 23 as illustrated in the center of the upper part of FIG. 8. For example, the incorrect values are corrected to correct values. Next, when the second error correction is performed once in a vertical direction, most of the individual regions 22 except for three individual regions 22 are replaced with the individual regions 23 as illustrated on a right side of the upper part of FIG. 8.

Moreover, when the third error correction is performed once in the horizontal direction, all of the three individual regions 22 are replaced with the individual regions 23 as illustrated on the left side of a lower part of FIG. 8. In this way, in the frame 20F having the low error frequency, all the incorrect values are corrected to correct values by the third error correction. Therefore, as illustrated in the center of the lower part of FIG. 8, even when the fourth error correction is performed once in the vertical direction, there is no individual region 22 as the error correction target, and thus, the power consumption needed for the error correction is suppressed. Furthermore, as illustrated on the right side of the lower part of FIG. 8, even when the fifth error correction is performed once in the horizontal direction, there is no individual region 22 as the error correction target, and thus, the power consumption needed for the error correction is suppressed.

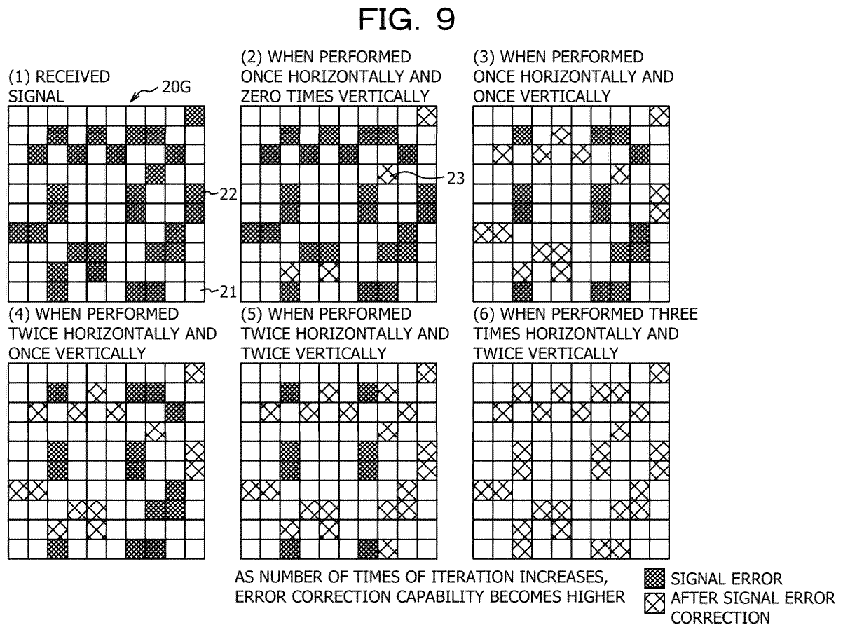

Next, as illustrated on a left side of an upper part of FIG. 9, a frame 20G having a moderate error frequency slightly higher than the error frequency of the frame 20F having the low error frequency described above may be input to the SD-FEC decoding unit 131 as a received signal. In this case, even when the first error correction is performed once in the horizontal direction, only four of the individual regions 22 are replaced with the individual regions 23 as illustrated in the center of the upper part of FIG. 9, and most of the individual regions 22 still remain. For example, most of the incorrect values remain without being corrected to correct values.

Next, when the second error correction is performed once in the vertical direction, about half of the individual regions 22 are replaced with the individual regions 23 as illustrated on a right side of the upper part of FIG. 9. Moreover, when the third error correction is performed once in the horizontal direction, most of the individual regions 22 except for ten individual regions 22 are replaced with the individual regions 23 as illustrated on the left side of a lower part of FIG. 9. Then, when the fourth error correction is performed once in the vertical direction, the majority of the individual regions 22 except for eight individual regions 22 are replaced with the individual regions 23 as illustrated in the center of the lower part of FIG. 9. Finally, when the fifth error correction is performed once in the horizontal direction, all of the individual regions 22 are replaced with the individual regions 23.

In this way, in the case of the frame 20G having the moderate error frequency, all the incorrect values are corrected to correct values by the fifth error correction. For example, in the case of the frame 20G having the moderate error frequency, the number of times of repetition of error correction increases as compared with the frame 20F having the low error frequency. Therefore, the power consumption needed for the error correction increases as compared with the frame 20F having the low error frequency. However, since all the incorrect values are finally corrected to the correct values, poor communication of the received signals is avoided.

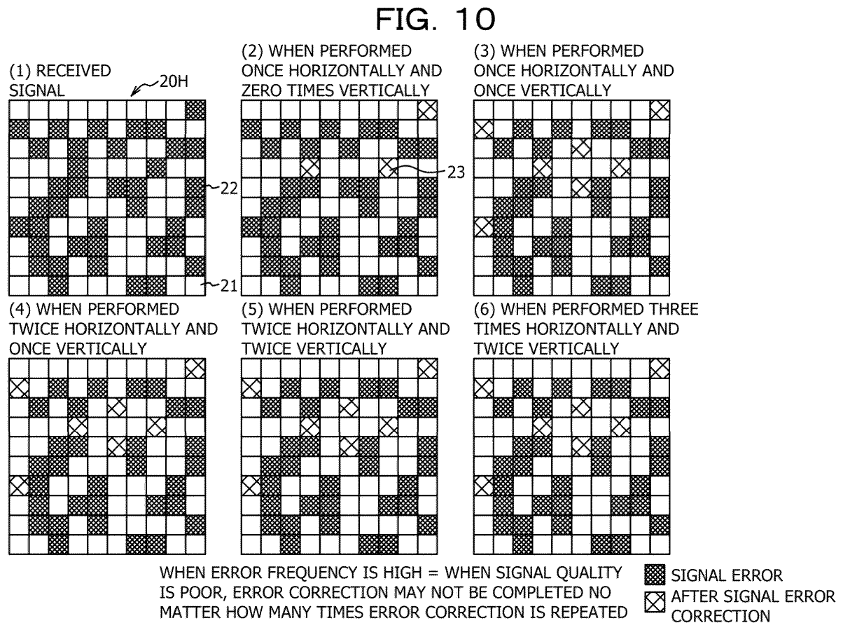

Note that, as illustrated on a left side of an upper part of FIG. 10, a frame 20H having a higher error frequency than the frame 20G having the moderate error frequency described above may be input to the SD-FEC decoding unit 131 as a received signal. In this case, even when the first error correction is performed once in the horizontal direction, only three of the individual regions 22 are replaced with the individual regions 23 as illustrated in the center of the upper part of FIG. 10, and most of the individual regions 22 still remain. For example, most of the incorrect values remain without being corrected to correct values.

Next, even when the second error correction is performed once in the vertical direction, most of the individual regions 22 remains without being replaced with the individual regions 23 as illustrated on a right side of the upper part of FIG. 10. Furthermore, even when the third error correction is performed once in the horizontal direction, most of the individual regions 22 remains without being replaced with the individual regions 23 as illustrated on the left side of a lower part of FIG. 10. Moreover, even when the fourth error correction is performed once in the vertical direction, the majority of the individual regions 22 remain without being replaced with the individual regions 23 as illustrated in the center of the lower part of FIG. 10. Finally, even when the fifth error correction is performed once in the horizontal direction, all of the individual regions 22 remain without being replaced with the individual regions 23.

In this way, in the case of the frame 20H having the high error frequency, all the incorrect values remain without being corrected to correct values even by the fifth error correction. For example, in the case of the frame 20H having the high error frequency, even when the number of times of repetition of error correction increases as compared with the frame 20G having the moderate error frequency, error correction may not be completed. For example, in the case of the frame 20H having the high error frequency, the power consumption needed for error correction increases as the number of times of repetition of the error correction increases, but poor communication of the received signal occurs. In the present embodiment, an upper limit value is set in the SD-FEC decoding unit 131 only in such a case where the poor communication occurs due to the frame 20H having the high error frequency, and the number of times of repetition is limited. As a result, it is possible to reduce the power consumption when error correction is performed on a frame having a high error frequency and low quality.

### Second Embodiment

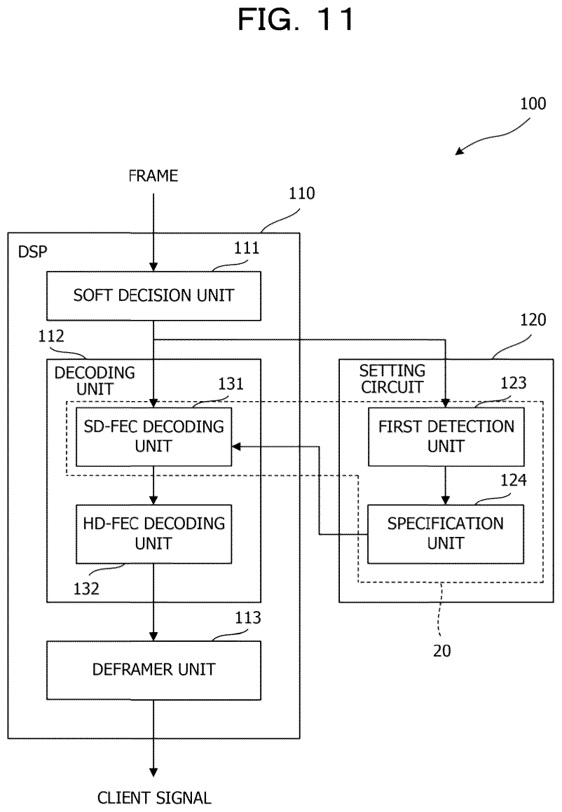

Subsequently, a second embodiment of the present embodiments will be described with reference to FIGS. 11 to 13. As illustrated in FIG. 11, a decoding circuit 100 may include an error correction device 20 instead of the error correction device 10. The error correction device 20 includes an SD-FEC decoding unit 131, a first detection unit 123, and a specification unit 124. The first detection unit 123 is an example of a first detection circuit. The specification unit 124 is an example of a specification circuit.

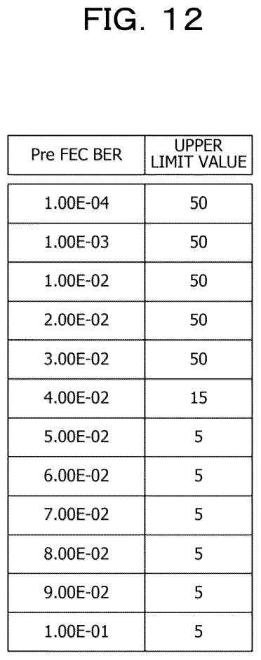

The first detection unit 123 detects quality of a frame before being input to the SD-FEC decoding unit 131. For example, the first detection unit 123 detects a Pre FEC BER representing quality before input to the decoding unit 112. The specification unit 124 specifies an upper limit value corresponding to the Pre FEC BER detected by the first detection unit 123. For example, as illustrated in FIG. 12, the specification unit 124 includes a correspondence table in which a plurality of the Pre FEC BERs and a plurality of the upper limit values are associated with each other for each Pre FEC BER.

According to this correspondence table, quality of a frame is determined to be low in a case where the Pre FEC BER is 4.00E-2 or more, and an upper limit value smaller than an upper limit value adopted in a case where the Pre FEC BER is greater than 4.00E-2 is adopted. As a result, in the case of a frame with low quality, power consumption is suppressed. Based on such a correspondence table, the specification unit 124 specifies an upper limit value corresponding to the Pre FEC BER detected by the first detection unit 123. After specifying the upper limit value, the specification unit 124 sets the specified upper limit value in the SD-FEC decoding unit 131.

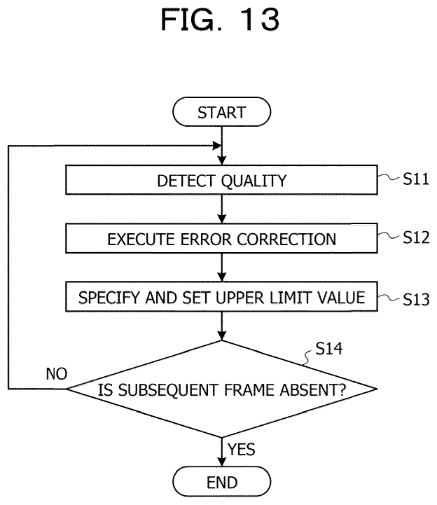

Operation of the error correction device 20 will be described with reference to FIG. 13.

The first detection unit 123 detects quality of a frame after the frame is output from a soft decision unit 111 and before the frame is input to a decoding unit 112 (operation S11). When the processing of operation S11 is completed, the SD-FEC decoding unit 131 executes error correction for the frame (operation S12). Note that the processing of operations S11 and 12 may be performed at the same timing.

When the processing of operation S12 ends, the specification unit 124 specifies an upper limit value, and sets the upper limit value in the SD-FEC decoding unit 131 (operation S13). For example, the specification unit 124 specifies an upper limit value corresponding to the quality detected by the first detection unit 123, and sets the specified upper limit value in the SD-FEC decoding unit 131. When the processing of operation S13 is completed, the SD-FEC decoding unit 131 determines presence or absence of a subsequent frame (operation S14).

In a case where there is a subsequent frame (operation S14: NO), the error correction device 20 repeats the processing from operation S11 to operation S13. As a result, the upper limit value is specified every time the frame is input, and set in the SD-FEC decoding unit 131. On the other hand, in a case where there is no subsequent frame (operation S14: YES), the SD-FEC decoding unit 131 ends the processing.

In this way, according to the second embodiment, an upper limit value corresponding to quality of a frame is set in the SD-FEC decoding unit 131. For example, in a case where the quality of the frame is low, a small upper limit value is adopted as compared with a case where the quality of the frame is high. As a result, the number of times of repetition needed for error correction in a case where the quality of the frame is low is reduced, and the power consumption is reduced. Note that, in the second embodiment, the description has been made using the Pre FEC BER as an example of the quality of the frame, but an SNR or an optical SNR (OSNR) may be adopted instead of the Pre FEC BER.

### Third Embodiment

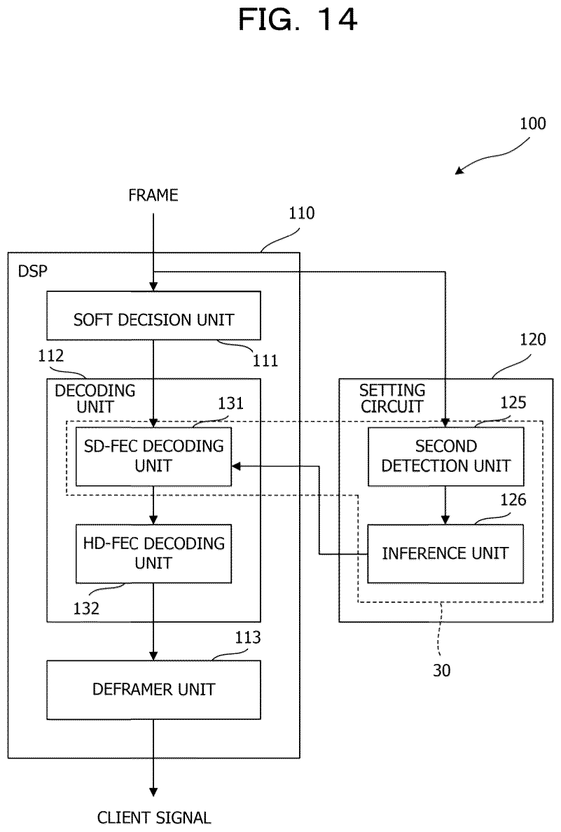

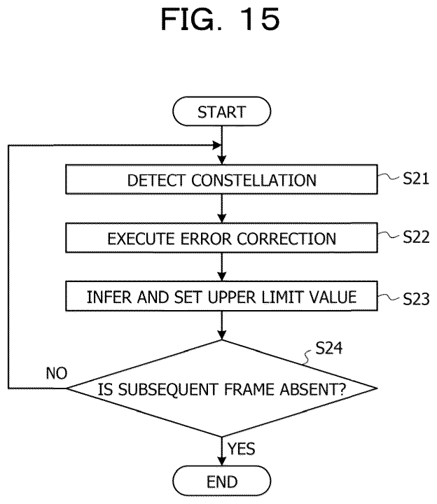

Subsequently, a third embodiment of the present embodiments will be described with reference to FIGS. 14 and 15. As illustrated in FIG. 14, a decoding circuit 100 may include an error correction device 30 instead of the error correction device 10. The error correction device 30 includes an SD-FEC decoding unit 131, a second detection unit 125, and an inference unit 126. The second detection unit 125 is an example of a second detection circuit. The inference unit 126 is an example of an inference circuit.

The second detection unit 125 detects a constellation of a plurality of symbols stored in a frame before being input to a soft decision unit 111. The inference unit 126 includes a trained model in which a constellation corresponding to quality of a frame and an upper limit value according to each constellation are machine-learned in advance. For example, the inference unit 126 includes a trained model in which a constellation of a plurality of symbols stored in a frame with low quality and an upper limit value smaller than an upper limit value corresponding to a frame with high quality are machine-learned. The inference unit 126 infers an upper limit value corresponding to the constellation detected by the second detection unit 125. After inferring the upper limit value, the inference unit 126 sets the inferred upper limit value in the SD-FEC decoding unit 131.

Operation of the error correction device 30 will be described with reference to FIG. 15.

The second detection unit 125 detects a constellation of a plurality of symbols stored in a frame before the frame is input to the soft decision unit 111 (operation S21). When the processing of operation S21 is completed, the SD-FEC decoding unit 131 executes error correction for the frame symbol-demapped by the soft decision unit 111 (operation S22).

When the processing of operation S22 ends, the inference unit 126 infers an upper limit value, and sets the upper limit value in the SD-FEC decoding unit 131 (operation S23). For example, the inference unit 126 infers an upper limit value corresponding to the constellation detected by the second detection unit 125, and sets the inferred upper limit value in the SD-FEC decoding unit 131. When the processing of operation S23 is completed, the SD-FEC decoding unit 131 determines presence or absence of a subsequent frame (operation S24).

In a case where there is a subsequent frame (operation S24: NO), the error correction device 30 repeats the processing from operation S21 to operation S23. As a result, the upper limit value is inferred every time the frame is input, and set in the SD-FEC decoding unit 131. On the other hand, in a case where there is no subsequent frame (operation S24: YES), the SD-FEC decoding unit 131 ends the processing.

In this way, according to the third embodiment, an upper limit value corresponding to a constellation of symbols stored in a frame is set in the SD-FEC decoding unit 131. For example, in a case where quality of the frame is low, a small upper limit value is adopted as compared with a case where the quality of the frame is high by the trained model. As a result, the number of times of repetition needed for error correction in a case where the quality of the frame is low is reduced, and the power consumption is reduced.

Although the preferred embodiments have been described in detail thus far, the present embodiments are not limited to specific embodiments, and various modifications and alterations may be made within the scope of the present embodiments described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An error correction device comprising:
an error correction circuit configured to repeatedly perform calculation of error correction on a target frame, based on soft decision information, an upper limit value of a number of times of calculation of the repeatedly performed calculation being set;
a first calculation circuit configured to count a number of times of repetition of the calculation of the error correction for each frame, and obtain a sum of numbers of times of repetition of a plurality of past frames; and
a second calculation circuit configured to set the upper limit value so as to be a value that corresponds to the sum of the numbers of times of repetition and to be a smaller value as the sum of the numbers of times of repetition is greater.

2. The error correction device according to claim 1, wherein the second calculation circuit sets, as the upper limit value, a value obtained by subtracting the sum of the numbers of times of repetition from a predetermined set number of times.

3. The error correction device according to claim 2, wherein the second calculation circuit determines the predetermined set number of times, based on a request value of received signal quality to suppress the number of times of repetition of the calculation of the error correction to a predetermined number of times of the error correction.

4. The error correction device according to claim 2, wherein the second calculation circuit determines the predetermined set number of times as a value for suppressing an increase in power consumption in received signal quality smaller than a request value of received signal quality to suppress the number of times of repetition of the calculation of the error correction to a predetermined number of times of the error correction.

5. An error correction device comprising:
an error correction circuit configured to repeatedly perform calculation of error correction on a target frame, based on soft decision information, an upper limit value of a number of times of calculation of the repeatedly performed calculation being set;
a first detection circuit configured to detect quality of a target frame; and
a specification circuit configured to specify an upper limit value that corresponds to the quality detected by the first detection circuit, based on a correspondence table in which the quality and the upper limit value that decreases according to deterioration of the quality are associated with each other for each quality, and set the specified upper limit value.

6. An error correction method for an error correction circuit, the error correction method comprising:
repeatedly performing calculation of error correction on a target frame, based on soft decision information, an upper limit value of a number of times of calculation of the repeatedly performed calculation being set;
counting a number of times of repetition of the calculation of the error correction for each frame, and obtaining a sum of numbers of times of repetition of a plurality of past frames; and
setting the upper limit value so as to be a value that corresponds to the sum of the numbers of times of repetition and to be a smaller value as the sum of the numbers of times of repetition is greater.

7. The error correction method according to claim 6, wherein quality of the target frame is detected, the upper limit value that corresponds to the detected quality is specified, based on a correspondence table in which the quality and the upper limit value that decreases according to deterioration of the quality are associated with each other for each quality, without obtaining of the sum of the numbers of times of repetition and setting of the upper limit value, and the specified upper limit value is set in the error correction circuit.

8. The error correction method according to claim 6, wherein a constellation of symbols stored in the target frame is detected, the upper limit value that corresponds to the detected constellation is inferred, based on a trained model in which the constellation and the upper limit value that decreases according to deterioration of quality of the constellation are machine-learned, without obtaining of the sum of the numbers of times of repetition and setting of the upper limit value, and the inferred upper limit value is set in the error correction circuit.
